(19) United States
(12) Patent Application Publication
(10) Pub. No.: US 2019/0213676 A1
(43) Pub. Date: Jul. 11, 2019

(54) METHOD AND DEVICE FOR OPERATING P2P FINANCIAL SERVICE ON THE BASIS OF STAGE, AND COMPUTER-READABLE RECORDING MEDIUM

(71) Applicant: Jae Jun SEO, Seoul (KR)

(72) Inventor: Jae Jun SEO, Seoul (KR)

(21) Appl. No.: 16/335,131

(22) PCT Filed: Sep. 21, 2017
(86) PCT No.: PCT/KR2017/010407

§ 371 Date: Mar. 20, 2019

(30) Foreign Application Priority Data
Sep. 21, 2016 (KR) 10-2016-0121022

(51) Int. Cl. G06Q 40/02; G06Q 20/08

(52) U.S. Cl. CPC G06Q 40/025; G06Q 20/085

(57) ABSTRACT

The present invention relates to a method and a device for operating a P2P financial service on the basis of a stage, and a computer-readable recording medium. The method for operating a P2P financial service on the basis of a stage comprises the steps in which: a P2P financial service server receives a stage-based P2P financial application transmission request directly or indirectly via a relay server from a user device; and the P2P financial service server transmits the stage-based P2P financial application directly or indirectly via the relay server to the user device, wherein the stage-based P2P financial application is implemented for generating or participating in a stage on the basis of the user device, and the stage may include a plurality of stage participation spaces.

### BACKGROUND

Peer-to-peer (P2P) finance is a credit loan service between a plurality of borrowers and loaners through an Internet open market. P2P finance rapidly grows globally. After interest in growth of micro-finance is amplified, a P2P-based Internet loan market has emerged as an alternative to a social credit loan.

While low credit rating persons that may not obtain a loan from regulatory financial institutions in the country are increasing, P2P finance has emerged as an alternative to a loan service of the financial underprivileged that may not use existing regulatory financial institutions.

P2P finance has a significantly low bad debt risk compared to an interest rate in spite of a default risk in the nature of borrowers and a credit loan through Internet. Accordingly, borrowers may obtain funds at an interest rate lower than that of credit, and loaners may obtain a profit higher than that of other investment technologies.

In existing P2P finance, users could not help using only financial products generated by operating companies operating P2P finance. Accordingly, users could not help manually selecting P2P financial products previously designed to correspond to a use object of financial products.

### SUMMARY

The present invention has been made in an effort to solve the above problems.

Further, the present invention has another object that receives an amount paid or invests surplus funds with a desired interest rate at a time point requiring a lump sum based on a direct design of and subscription in a P2P financial product (or stage) according to a user object.

Further, the present invention has another object that stably operates a P2P financial product by analyzing stability of a P2P financial product subscribed by the user by reflecting in real time the change in a credit rating according to stage subscription of the user.

Typical configurations of the present invention for achieving the above objects are as follows.

According to one aspect of the invention, a method of operating a peer-to-peer (P2P) financial service based on a stage includes receiving, by a P2P financial service server, a transmission request of a stage-based P2P financial application from a user equipment directly or indirectly through a relay server; and transmitting, by the P2P financial service server, the stage-based P2P financial application to the user equipment directly or indirectly through the relay server, wherein the stage-based P2P financial application is implemented to generate a stage or participate in a stage based on the user equipment, the stage includes a plurality of stage participation spaces, the plurality of stage participation spaces sequentially correspond to a plurality of stage orders, respectively, the user's payment amount and/or amount paid are/is determined on the stage according to a stage order allocated to a user of the user equipment among the plurality of stage orders, and a paid time of the amount paid on the stage is determined according to the stage order.

According to another aspect of the invention, a P2P financial service server for operating a peer-to-peer (P2P) financial service based on a stage includes a communication unit for communicating with a relay server or a user equipment; and a processor operatively connected to the communication unit, wherein the processor is implemented to receive a transmission request of a stage-based P2P financial application from the user equipment directly or indirectly through a relay server, and to transmit a stage-based P2P financial application to the user equipment directly or indirectly through the relay server, the stage-based P2P financial application is implemented to generate a stage or participate in a stage based on the user equipment, the stage includes a plurality of stage participation spaces, the plurality of stage participation spaces sequentially correspond to a plurality of stage orders, respectively, the user's payment amount and/or amount paid are/is determined on the stage according to a stage order allocated to a user of the user equipment among the plurality of stage orders, and a paid time of the amount paid on the stage is determined according to the stage order.

According to the present invention, users can receive an amount paid or invest surplus funds with a desired interest rate at a time point requiring a lump sum based on a design of and subscription to a direct P2P financial product (or stage) according to an object.

Further, according to the present invention, by analyzing stability of a P2P financial product subscribed by the user by reflecting in real time the change in a credit rating according to the user's stage subscription, the P2P financial product can be stably operated.

### BRIEF DESCRIPTION OF THE FIGURES

FIG. 1 is a conceptual diagram illustrating a stage-based peer-to-peer (P2P) financial service operating system according to an embodiment of the present invention.

FIG. 2 is a conceptual diagram illustrating a stage-based P2P financial service according to an embodiment of the present invention.

FIG. 3 is a conceptual diagram illustrating a stage generation method according to an embodiment of the present invention.

FIG. 4 illustrates a method of determining a user's credit rating according to an embodiment of the present invention.

FIG. 5 is a conceptual diagram illustrating variable risk elements according to an embodiment of the present invention.

FIG. 6 is a conceptual diagram illustrating variable risk elements according to an embodiment of the present invention.

FIG. 7 is a conceptual diagram illustrating variable risk elements according to an embodiment of the present invention.

FIG. 8 is a conceptual diagram illustrating variable risk elements according to an embodiment of the present invention.

FIG. 9 is a conceptual diagram illustrating variable risk elements according to an embodiment of the present invention.

FIG. 10 is a conceptual diagram illustrating variable risk elements according to an embodiment of the present invention.

FIG. 11 is a conceptual diagram illustrating a method of determining a user's credit rating according to an embodiment of the present invention.

FIG. 12 is a conceptual diagram illustrating a method of determining a real-time credit rating of a P2P financial service server according to an embodiment of the present invention.

FIG. 13 is a conceptual diagram illustrating a method of determining stage order according to an embodiment of the present invention.

FIG. 14 is a conceptual diagram illustrating a method of determining a user's credit rating based on the user's test results according to an embodiment of the present invention.

FIG. 15 is a conceptual diagram illustrating succession among users in a stage according to an embodiment of the present invention.

FIG. 16 is a conceptual diagram illustrating a determination procedure of a P2P service financial server for succession among users in a stage according to an embodiment of the present invention.

FIG. 17 is a conceptual diagram illustrating a combination procedure between stages according to an embodiment of the present invention.

FIG. 18 is a conceptual diagram illustrating a method of recommending a stage to a user according to an embodiment of the present invention.

FIG. 19 is a conceptual diagram illustrating a method of transmitting product advertisement information to a user in consideration of category information of a stage according to an embodiment of the present invention.

### DETAILED DESCRIPTION

The following detailed description of the invention refers to the accompanying drawings, which illustrate, by way of illustration, specific embodiments in which the invention may be practiced. These embodiments are described in sufficient detail to enable those skilled in the art to practice the invention. It should be understood that various embodiments of the present invention are different, but need not be mutually exclusive. For example, specific shapes, structures, and characteristics described herein may be implemented by changing from one embodiment to another embodiment without departing from the spirit and scope of the invention. It should also be understood that the location or arrangement of individual components within each embodiment may be varied without departing from the spirit and scope of the present invention. Therefore, the following detailed description is not to be taken in a limiting sense, and the scope of the present invention should be construed as encompassing the scope of the appended claims and all equivalents thereof. Like reference numerals in the drawings indicate the same or similar elements throughout several aspects.

Hereinafter, various embodiments of the present invention will be described in detail with reference to the accompanying drawings so that those skilled in the art can easily carry out the present invention.

Hereinafter, a user equipment (UE) may be referred to as various names such as a mobile terminal, a wireless device, a wireless transmit/receive unit (WTRU), a mobile station (MS), a mobile subscriber unit, or simply a user. For example, the UE may be a device such as a smartphone, a tablet, and a laptop computer.

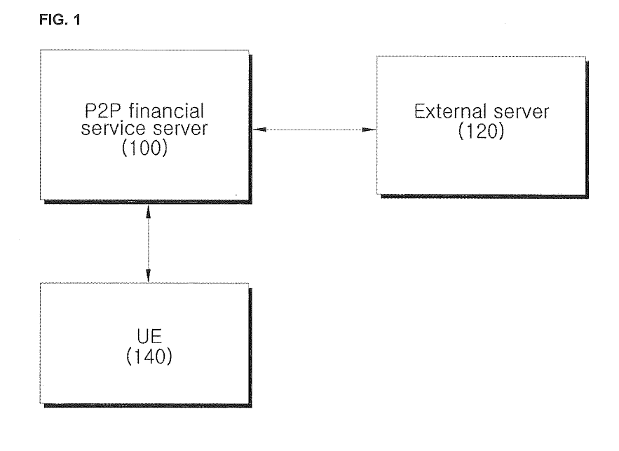

FIG. 1 is a conceptual diagram illustrating a stage-based peer-to-peer (P2P) financial service operating system according to an embodiment of the present invention.

Referring to FIG. 1, a stage-based P2P financial service operating system may include a P2P financial service server 100, an external server 120, and a UE 140.

The P2P financial service server 100 may transmit a stage-based P2P financial application to the UE.

The P2P financial service server 100 may receive a transmission request of a stage-based P2P financial application from the UE 140 directly or indirectly through a relay server and may transmit a stage-based P2P financial application to the UE 140 directly or indirectly through a relay server.

The stage-based P2P financial application may be implemented to provide a stage-based P2P financial service to users. Specifically, the stage-based P2P financial application may be implemented for use (e.g., design of and/or subscription to the stage) of the stage-based P2P financial service by users. Further, the stage-based P2P financial application may be implemented to provide necessary information to a user based on a use object of the user's P2P financial service. For example, when a use object of the user's stage-based P2P financial service is purchase of a specific product, the stage-based P2P financial application may provide may be implemented to provide information about the product to the users. A stage-based P2P financial service to be provided based on the stage-based P2P financial application will be described later in detail.

Further, the P2P financial service server 100 may determine a user's credit rating based on internal user credit information and external user credit information and restrict use of the user's stage-based P2P financial service according to a credit rating.

The internal user credit information may include use records of the stage-based P2P financial service based on the user's stage-based P2P financial application.

The external user credit information may be information related to a user credit received from the external server 120 that provides credit information.

The external server 120 may provide information related to a user credit. For example, the external server 120 is a server of a credit rating company and may generate the user's credit rating information based on the user's existing financial related record.

Further, the external server 120 may be a server for providing advertising information through the P2P financial service server.

The UE 140 may receive a stage-based P2P financial application from the P2P financial service server 100 or a relay server that provides an application. The user may receive a stage-based P2P financial service based on the stage-based P2P financial application installed in the UE 140.

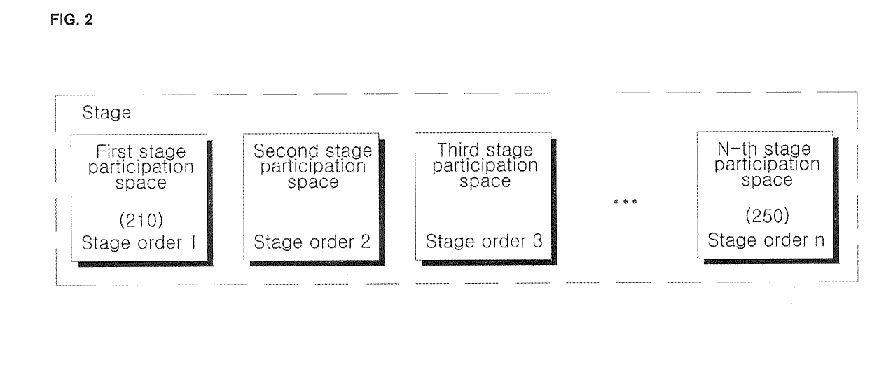

FIG. 2 is a conceptual diagram illustrating a stage-based P2P financial service according to an embodiment of the present invention.

FIG. 2 illustrates a stage-based P2P financial service provided based on the user's stage-based P2P financial application.

Referring to FIG. 2, the stage-based P2P financial service may be provided based on a stage set by the user.

The stage may be generated by a particular user, and a particular user generating a stage may be expressed with a term of a stage generation user. A user participating in a stage generated by the stage generation user may be expressed with a term of a stage participation user.

A stage generated by the stage generation user may include a plurality of stage participation spaces, and the plurality of stage participation spaces may be allocated to the stage generation user and a plurality of stage participation users participating in the stage in order. The plurality of stage participation spaces may be implemented to determine an amount paid according to the stage order and/or a payment amount according to the stage order on the stage.

Specifically, there may be assumed a stage including the n (where n is a natural number of 2 or more) number of stage participation spaces (a first stage participation space 210 to the n-th stage participation space 250) having sequential order and in which a payment procedure of the total n number of payment amounts and a paid procedure of the total n number of amounts paid are performed. Hereinafter, payment of the n-th round payment amount may be expressed with a term of payment of the n-th round payment amount, and paid of the n-th round amount paid may be expressed with a term of paid of the n-th amount paid. For convenience of description, it is assumed that the number of stage participation spaces is the same as the payment round number of a payment amount, but the number of stage participation spaces may be different from the payment round number of a payment amount.

The user's first round payment amount to n-number round payment amount is determined according to the stage participation space (or stage order) allocated to the user in the stage, and the user may pay the first round payment amount to the n-th round payment amount. Alternatively, the user's first round payment amount to n-th round payment amount may not change according to the stage participation space (or stage order) allocated to the user in the stage.

Further, when the x-th stage participation space of the n-number of stage participation spaces (or stage order) is allocated to the user in the stage (when the user's stage order is x), the user may receive the x round amount paid at an x round.

The user may select a stage participation space according to the subscription object of the stage. For example, when the user needs urgently a large amount, in order to receive an amount paid at a round of relatively fast unsubordinated order, the user may request allocation to the stage participation space 210 (e.g., the first stage participation space (or stage order 1)) of relatively fast unsubordinated order. When the stage participation space of relatively fast unsubordinated order is allocated to the user, the user may receive an amount paid in relatively unsubordinated order, but the amount paid may be smaller than a total amount of payment amounts. In another embodiment, the user's first round payment amount to n-th round payment amount may be adjusted to be relatively high.

In order words, a user, having received allocation of the stage participation space of relatively fast unsubordinated order may use the stage for the purpose of the loan, and the user may pay a first round payment amount to the n-th round payment amount relatively further including an interest of a loan amount.

For example, in a stage including the n (e.g., n is an even number) number of stage participation spaces, the first stage participation space 210 to the (n/2)th stage participation space, which are unsubordinated order may be used by the user who uses a stage for the purpose of a loan.

Conversely, when the user does not need urgently a large amount of money but wants to obtain a financial income such as an interest using extra money, in order to receive an amount paid at a round of relatively slow subordinated order, the user may request allocation to a stage participation space (e.g., the n-th stage participation space (or stage order n)) 250 of subordinated order. When a stage participating space of relatively slow subordinated order is allocated, the user may receive an amount paid more than a total amount of payment amounts including an interest of a loan amount paid by other users of unsubordinated order in the allocated subordinated order. In another embodiment, the user's first round payment amount to n-th round payment amount may be adjusted to be relatively low.

In order words, a user, having received allocation of a stage participating space of relatively slow subordinated order may receive a loan interest paid by users of unsubordinated order as a financial income by using the stage for the purpose of investment.

For example, in a stage including the n (e.g., n is an even number) number of stage participation spaces, the (n/2)th stage participation space to the n-th stage participation space 250, which are unsubordinated order may be used by the user using a stage for the purpose of investment.

The number of stage participation spaces based on the stage-based P2P financial application, a payment amount, an interest rate according to the order of the stage participation space, information (category of the stage, start date) about the stage, and financial account information (payment account of the payment amount, payment account of the amount paid) may be directly set by the user. That is, the user may open and operate a stage according to the user's operation object of the stage. For example, when the user needs urgently a laptop computer, the user may open a stage for buying the laptop computer, obtain unsubordinated order, receive an amount paid, and purchase the laptop computer. When the user receives allocation of a stage participation space (or stage order of unsubordinated stage order) of unsubordinated order, a payment amount more than the amount paid may be paid.

Conversely, when the user wants to obtain a financial income, the user may open a stage, receive allocation of a stage participation space of subordinated order (or stage order of unsubordinated order), and receive a relatively high amount paid further including a loan interest amount paid by other users of unsubordinated order.

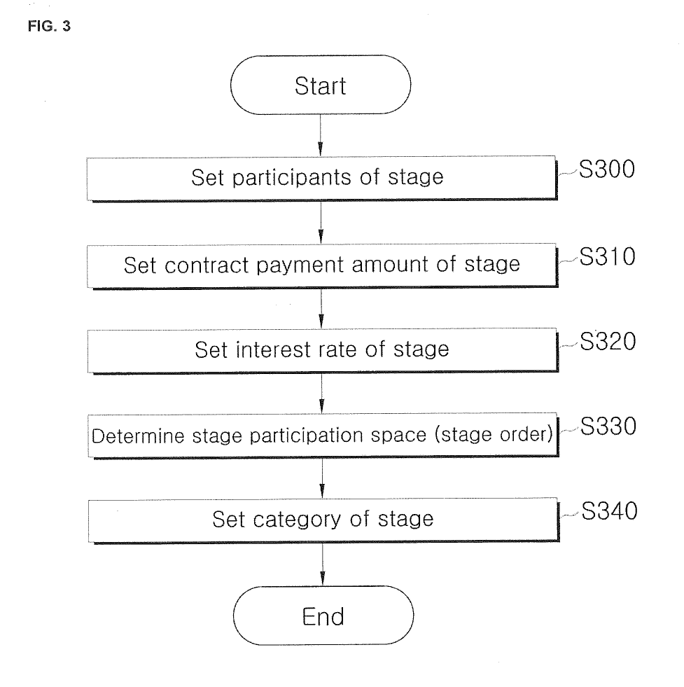

FIG. 3 is a conceptual diagram illustrating a stage generation method according to an embodiment of the present invention.

FIG. 3 illustrates a method of generating a stage by the user.

Referring to FIG. 3, the user may set participants of the stage (step S300).

For example, the user may select one of the number (e.g., 5, 7, 9, and 13) of personnel that can be set to stage participants on the stage-based P2P financial application.

A procedure of setting participants of the stage may be a procedure of setting the number of stage participation spaces in order words. According to an embodiment of the present invention, the number of stage participation spaces and the number of payment rounds of a payment amount may be the same. That is, when the number of stage participation spaces is selected, the number of payment rounds of a payment amount may be also automatically determined. When a payment round is set in a unit of a month, an expiration period of the stage may be determined based on the number of stage participation spaces. Hereinafter, in an embodiment of the present invention, a period of the payment (or payment round) is assumed to a month (or 30 days), but a period of the payment (or payment round) may be set differently.

The user may select a contract payment amount of the stage (step S310).

The user may determine a payment amount to be paid for each round. For example, a contract amount may be set to 100 thousand won in a month, and users participating in the stage may pay 100 thousand won in a month.

The user may set an interest rate of the stage (step S320).

The user may set a financial income that may be obtained through the stage to an interest rate. For example, the user may select one of a plurality of interest rates (6%, 6.5%, 7%, 8%, 9%, 10%, 11%, 12%, 13%, 14%, 15%, and 16%) set on the stage-based P2P financial application.

The user may determine a stage participation space (or stage order) (step S330).

A stage generation user may preferentially set stage order in a stage generated by the stage generation user. For example, when the user generates a stage for the purpose of a loan, the user may select stage order of relatively unsubordinated order. Conversely, when the user generates a stage for the purpose of investment, the user may select stage order of relatively subordinated order.

When a stage operating based on 13 users is selected, 13 stage participation spaces may be allocated to the stage, and the 13 stage participation spaces may be sequentially receive allocation of 13 stage orders, respectively.

Table 1 discloses information about a total payment amount according to stage order of each of 13 stage participation spaces and an amount paid, an interest, a real interest rate, and an amount paid (or real amount paid) of the stage order.

TABLE 1

| | | | | Real | | |
|---|---|---|---|---|---|---|
| | Total | Corresponding | | interest | Withholding of | Actual |
| Net | payment | order amount | Interest | rate | interest income | amount |
| order | amount | paid | (pre-tax) | (pre-tax) | tax | paid |
| 1 | 1,300,000 | 1,221,984 | −78,016 | −6.00% | | 1,221,984 |
| 2 | 1,300,000 | 1,231,624 | −68,376 | −5.26% | | 1,231,624 |
| 3 | 1,300,000 | 1,242,754 | −57,246 | −4.40% | | 1,242,754 |
| 4 | 1,300,000 | 1,253,954 | −46,046 | −3.54% | | 1,253,954 |
| 5 | 1,300,000 | 1,264,954 | −35,046 | −2.70% | | 1,264,954 |
| 6 | 1,300,000 | 1,275,954 | −24,046 | −1.85% | | 1,275,954 |
| 7 | 1,300,000 | 1,287,000 | −13,000 | −1.00% | | 1,287,000 |
| 8 | 1,300,000 | 1,301,596 | 1,596 | 0.12% | 420 | 1,301,176 |
| 9 | 1,300,000 | 1,309,996 | 9,996 | 0.77% | 2,730 | 1,307,266 |
| 10 | 1,300,000 | 1,319,596 | 19,596 | 1.51% | 5,370 | 1,314,226 |
| 11 | 1,300,000 | 1,329,996 | 29,996 | 2.31% | 8,230 | 1,321,766 |
| 12 | 1,300,000 | 1,341,196 | 41,196 | 3.17% | 11,310 | 1,329,886 |
| 13 | 1,200,000 | 1,250,396 | 50,396 | 4.20% | 13,840 | 1,236,556 |

Referring to Table 1, the user of the stage order 1 to the stage order 7 may use the stage for the purpose of a loan. The user, having received allocation of the stage order 1 to the stage order 7 may receive an amount paid smaller than an amount of 1.3 million won in which 13 times are paid by 100 thousand won, but receive a loan at a time requiring 1.3 million won. Conversely, the user, having received allocation of the stage order 8 to the stage order 13 may use the stage for the purpose of a loan. The user of the stage order 8 to the stage order 12 may receive an amount paid higher than an amount of 1.3 million won in which 13 times are paid by 100 thousand won, and the user of the stage order 13 may pay 1.2 million won and receive an amount paid higher than a pay amount.

Table 2 discloses information about an expected receiving amount, an interest (loan interest, and installment saving interest), a pay amount, a total pay amount, and an applicable interest rate according to stage order of each of 13 stage participation spaces.

TABLE 2

| | Expected | | Installment | | | Total | Applicable |
|---|---|---|---|---|---|---|---|
| | amount to be | Loan | saving | Total | Payment | payment | interest |
| Order | received | interest | interest | interest | amount | amount | rate |
| 1 | 1,300,000 | −43,940 | 0 | −43,940 | 103,380 | 1,343,940 | 5.74% |
| 2 | 1,300,000 | −40,278 | 3,662 | −36,617 | 102,817 | 1,336,617 | 4.79% |
| 3 | 1,300,000 | −36,617 | 7,323 | −29,293 | 102,253 | 1,329,293 | 3.84% |
| 4 | 1,300,000 | −32,955 | 10,985 | −21,970 | 101,690 | 1,321,970 | 2.88% |
| 5 | 1,300,000 | −29,293 | 14,647 | −14,647 | 101,127 | 1,314,647 | 1.93% |
| 6 | 1,300,000 | −25,632 | 18,308 | −7,323 | 100,563 | 1,307,323 | 0.96% |
| 7 | 1,300,000 | −21,970 | 21,970 | 0 | 100,000 | 1,300,000 | 0.00% |
| 8 | 1,300,000 | −18,308 | 25,632 | 7,323 | 99,437 | 1,292,677 | 1.13% |
| 9 | 1,300,000 | −14,647 | 29,293 | 14,647 | 98,873 | 1,285,353 | 2.28% |
| 10 | 1,300,000 | −10,985 | 32,955 | 21,970 | 98,310 | 1,278,030 | 3.44% |
| 11 | 1,300,000 | −7,323 | 36,617 | 29,293 | 97,747 | 1,270,707 | 4.61% |
| 12 | 1,300,000 | −3,662 | 40,278 | 36,617 | 97,183 | 1,263,383 | 5.80% |
| 13 | 1,300,000 | 0 | 43,940 | 43,940 | 96,620 | 1,256,060 | 7.00% |

Referring to Table 2, there is disclosed the stage designed so that a receiving amount is the same according to the order, but a payment amount varies according to order. An interest may be classified into a loan interest and an installment saving interest, and the sum of a loan interest and an installment saving interest may be a total interest.

In stage order 1 to stage order 6, a loan interest may be higher than an installment saving interest for the purpose of a loan. In stage order 7 to stage order 13, a loan interest may be the same as or lower than an installment saving interest for the purpose of investment.

Further, two stage orders are paired, and the stage may be designed so that the sum of interests of each of the two paired stage orders has a symmetrical structure. For example, as stage order 1 and stage order 2 are paired, a total interest (−43,940 won) of the stage order 1 and a total interest (43,940 won) of the stage order 13 may have a symmetrical structure, and as the stage order 2 and stage order 12 are paired, a total interest (−36,617 won) of the stage order 2 and a total interest (36,617 won) of the stage order 12 may have a symmetrical structure.

A stage structure of Tables 1 and 2 is an illustration, and various stage structures may be designed.

The user may set a category of the stage (step S340).

The user may set information about an operating object of the stage. For example, a category of the stage may be set to a lump sum, computer/electronic appliance, travel, fashion accessories, beauty, musical instruments, wedding, baby, furniture/interiors, automotive/motorcycle, sporting goods, medical/smart device, and the like, and the user may operate the stage and set in advance whether the user wants a lump sum and purchase of a product.

Additionally, the user may set whether to open the stage.

The user may operate publicly or privately the stage.

When the stage is publicly operated, information about the stage may be transferred to another other and participation in another user's stage may be induced.

When the stage is privately operated, by setting a password, only other persons, having received information about the password by the user may participate in the stage.

Further, the user may input information about a start date (or recruitment time limit) of the stage, a deposit account for receiving a payment amount from users, and a payment account for receiving an amount to be paid to the user.

A stage is generated by the above user setting, and other users may subscribe to the generated stage. When the preset persons (e.g., 13 persons) are allocated to the preset participation stage, the stage may be started. A stage allocated to persons set to all preset stage participation stages may be expressed with a term of an allocation success stage.

When preset persons are not allocated to all preset stage participation stages and when a predetermined period has elapsed, the stage may be terminated without being started. A stage in which preset persons are not allocated to all preset participation spaces may be expressed with a term of an allocation failure stage.

The P2P financial service server may generate an allocation success stage through combination between allocation failure stages. Combination between allocation failure stages will be described later.

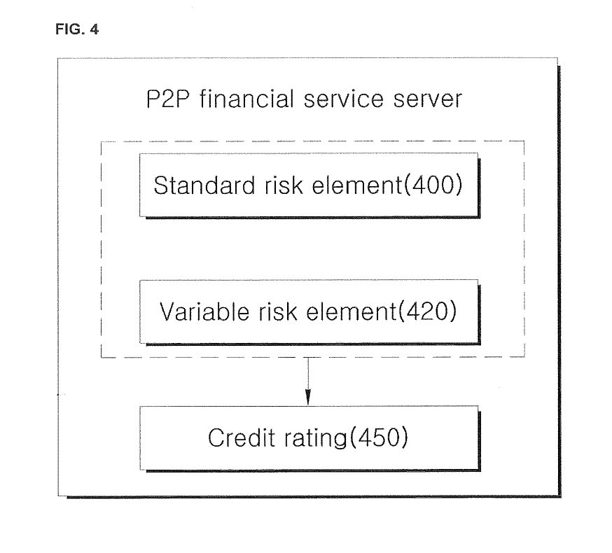

FIG. 4 illustrates a method of determining a user's credit rating according to an embodiment of the present invention.

FIG. 4 illustrates a method of determining the user's credit rating for a stable operation of the stage. When a particular user receives only an amount paid in unsubordinated order and does not pay a payment amount, the stage is not complete, and other users participated in the stages may be damaged.

Therefore, according to an embodiment of the present invention, the P2P financial service server may determine the user's standard risk element 400 and variable risk element 420 based on internal user credit information and external user credit information and determine the user's credit rating 450 based on the user's standard risk element 400 and variable risk element 420.

Table 3 represents the standard risk element 400 and the variable risk element 420 for determining the user's credit rating 450.

TABLE 3

| Division | Element | Weight |
|---|---|---|
| Standard risk | NICE credit rating | 40% |
| element | CL-BALANCE (credit | 10% |
| | loan balance) | |
| Variable risk | OPR (overdue payment rate) | 20% |
| element | SN (selection number) | 10% |
| | CLA (credit loan amount) | 10% |
| | POU (period of utilization) | 5% |
| | SNE (social network | 2% |
| | estimation) | |
| | AR (age risk) | 2% |
| | DS (data supplement) | 1% |
| | Sum | 100% |

A credit rating 450 of a user using the stage may be determined based on at least one of the standard risk element 400 and the variable risk element 420 disclosed in Table 3. Further, a weight allocated to each of the standard risk element 400 and the variable risk element 420 may be varied as an illustrative value.

NICE credit rating information may include information about credit rating distribution of NICE reference ratings 1 to 6. NICE credit rating information may be reliable data for managing credit information of 44 million persons and correspond to external user credit information. The P2P financial service server may calculate a first partial risk rate NICE based on information about a NICE credit rating and a weight of the information about a NICE credit rating.

CL-BALANCE information may include information about credit loan balance. The P2P financial service server may calculate a second partial risk rate CL-BALANCE based on CL-BALANCE information including information about the user's credit loan balance and a weight of the CL-BALANCE Information.

The variable risk element 420 may be internal user credit information.

OPR information may include information about the cumulative payment number of a pay amount in the stage and information about the overdue number of a pay amount. The P2P financial service server may calculate a third partial risk rate OPR based on OPR information and a weight of the OPR information.

SN information may include information about the user's stage order in the stage. A risk difference may exist between order of an unsubordinated order stage and order of a subordinated order stage in a characteristic of the stage. The P2P financial service server may calculate a fourth partial risk rate SN based on SN information and a weight of the SN information.

CLA information may include information about distribution loans of users who subscribe (generate or participate) to a plurality of stages. Hereinafter, a meaning of subscription to the stage may include a meaning of receiving allocation of stage order and proceeding a stage by generating a stage or participating in an already generated stage.

When the user uses a plurality of stages for the purpose of a loan, a risk of the stage may increase due to the user and thus the user's credit rating may be determined based on CLA information. The P2P financial service server may calculate a fifth partial risk rate CLA based on CLA information and a weight of the CLA information.

POU information may include information about the stage number completed by the user and the user's stage use period. When the user is completed at least one stage, the user's credit rating may be adjusted in consideration of the completion number of the stage and a payment period of the completed stage. The P2P financial service server may calculate a sixth partial risk rate POU based on POU information and a weight of the POU information.

SNE information may include information about the relationship between the user and other users. For example, when the user and other users are in an already aware relationship (or connected relationship based on a social network) and subscribe to the same stage, the P2P financial service server may determine that reliability of the stage is high and adjust the user's credit rating. The P2P financial service server may calculate a seventh partial risk rate SNE based on SNE information and a weight of the SNE information.

AR information may include information about a user age. The P2P financial service server may determine whether a user is the unemployed or a person under a predetermined age to adjust the user's credit rating 450. The P2P financial service server may calculate an eighth partial risk rate AR based on AR information and a weight of the AR information.

DS information may include information related to the user's income/property. The P2P financial service server may receive information related to additional income/property from the user to adjust the user's credit rating 450. The P2P financial service server may calculate a ninth partial risk rate DS based on DS information and a weight of the DS information.

The P2P financial service server may add the first partial risk rate NICE to the ninth partial risk rate DS to determine the user's credit rating (e.g., first rating and 15th rating) 450. The P2P financial service server may give the use right for the stage to only users corresponding to the credit rating 450 of a predetermined credit rating or less (e.g., first rating to ninth rating) and the credit rating 450 and restrict use of the stage to users corresponding to the credit rating 450 of the remaining 10th rating to 15th rating.

Further, the P2P financial service server may set different payment limits (basic limit, special limit) according to the credit rating 450.

Further, the P2P financial service server may reflect in real time use records in the user's stage to adjust the user's credit rating 450 in real time. For example, when the user receives allocation of unsubordinated order to continuously subscribe to the stage, the user's credit rating 450 may be lowered in real time and then the user's stage use may be limited.

Specifically, the P2P financial service server may determine whether the user may generate a stage or participate in a stage based on the user's first credit rating, and when the P2P financial service server may determine adjustment from the first credit rating to a second credit rating based on the user's use records in the stage while operating the stage.

The first credit rating may be determined based on the user's use records in the previous stage through the stage-based P2P financial application, and the second credit rating may be adjusted based on the user's use records in the stage.

The first credit rating may be determined based on information related to completion of the previous stage, information related to previous stage order selected in the previous stage, and information related to delinquency of a previous payment amount in the previous stage. The second credit rating may be adjusted based on information about stage order of a current stage and information related to delinquency of a payment amount in the current stage. The second credit rating may be determined by further considering information about other users who form a social network with users subscribed to the stage. A selectable range of the stage order may be determined based on another stage order selected by the user in other stages.

Hereinafter, the variable risk rate 420 is specifically disclosed. Hereinafter, the numerical value/table used for describing the variable risk rate 420 may be risk rate as an illustrative value.

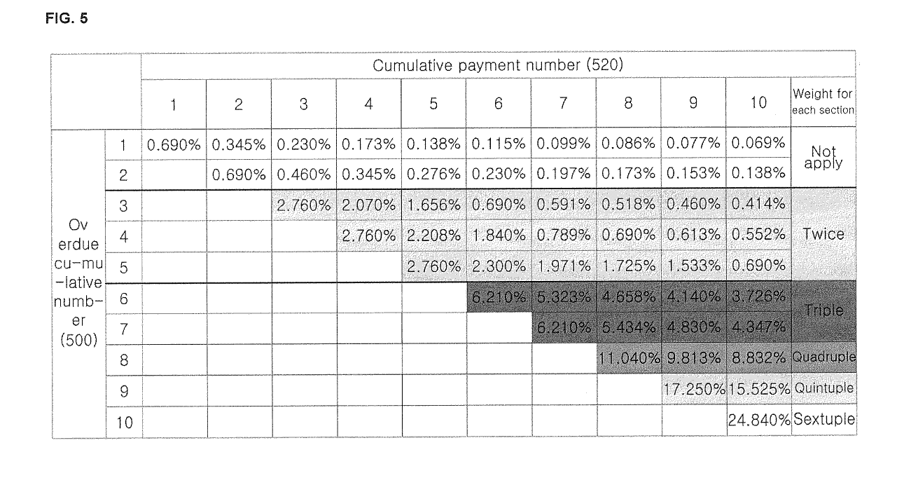

FIG. 5 is a conceptual diagram illustrating variable risk elements according to an embodiment of the present invention.

FIG. 5 illustrates a method of calculating a third partial risk rate OPR based on OPR information including information about a cumulative payment number 520 and an overdue cumulative number 500 and a weight of the OPR information.

Referring to FIG. 5, a table for calculating a third partial risk rate OPR based on the cumulative payment number 520 and the overdue cumulative number 500 is disclosed.

The third partial risk rate may be determined based on the overdue cumulative number 500 of a payment amount, the cumulative payment number 520 of a payment amount, an average reference risk rate, a weight for each section, and an additional weight. Equation 1 is an equation for calculating a third partial risk rate.

Third partial risk rate=(overdue cumulative number/cumulative payment number)×average reference risk rate×weight for each section x additional weight×third partial risk rate weight <Equation 1>

The average reference risk rate may be an average value of risk rates of NICE credit ratings to be a reference for calculating the above-mentioned partial risk rate. For example, the average reference risk rate may be 0.69%.

The cumulative payment number 520 may be a cumulative value of the payment number of a payment amount that should pay to at least one stage based on a current time point when using at least one stage on a user's stage-based P2P financial service. For example, when a user subscribed to two stages (first stage, second stage), when total five payment rounds have occurred in the first stage based on a current time point, and when total seven payment rounds have occurred in the second stage, the cumulative payment number 520 may be 12 times.

The overdue cumulative number 500 may include information about the payment number of an overdue payment amount based on a current time point when using at least one stage on a user's stage-based P2P financial service. For example, when a user subscribed to two stages (first stage, second stage), when two times of total five payment rounds have been overdue in the first stage based on a current time point, and when total one time of total seven payment rounds have been overdue in the second stage, the overdue cumulative number 500 may be 3 times.

A weight for each section may be a weight according to increase in the overdue cumulative number 500. For example, a weight for each section may be not applied to the overdue cumulative number 500 of two times, a twice weight for each section may be applied to the overdue cumulative number 500 of three times or five times, a triple weight for each section may be applied to the overdue cumulative number 500 of 6 times and 7 times, a quadruple weight for each section may be applied to the overdue cumulative number 500 of eight times, a quintuple weight for each section may be applied to the overdue cumulative number 500 of nine times, and a sextuple weight for each section may be applied to the overdue cumulative number 500 of ten times.

The additional weight may be a weight applied to a section in which the overdue cumulative number 500 to the cumulative payment number 520 exceeds 50%. The additional weight is the square of a weight for each section and may have a weight of minimum four times to maximum 36 times. For example, when three overdue cumulative number among total four payment times has occurred, four times, which is the square of two times of a weight for each section may be an additional weight. When the overdue cumulative number 500 to the cumulative payment number 520 does not exceed 50%, an additional weight may not be applied.

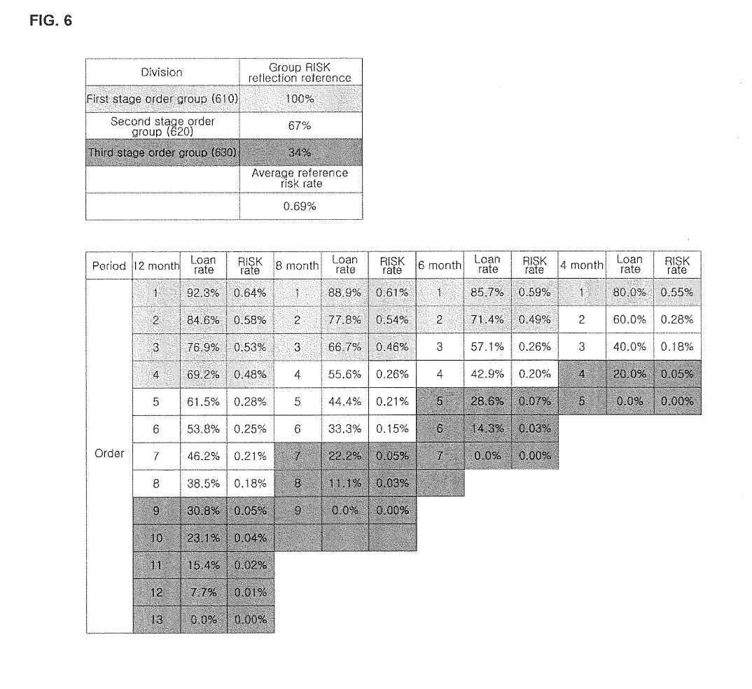

FIG. 6 is a conceptual diagram illustrating variable risk elements according to an embodiment of the present invention.

FIG. 6 illustrates a method of calculating a fourth partial risk rate SN based on SN information including information about a user's stage order on the stage and a weight of the SN information. In FIG. 6, a case is assumed in which a stage participation space of the stage is 13, 9, 7, or 5.

Referring to FIG. 6, the fourth partial risk rate SN may be determined based on a loan ratio of stage order, an average reference risk rate, and a group risk reflection rate. For example, the fourth partial risk rate SN may be calculated based on Equation 2.

Fourth partial risk rate SN=loan ratio of stage order×average reference risk rate x group risk reflection rate×fourth partial risk rate weight <Equation 2>

Equation 2 is a fourth partial risk rate in one stage. When the user participates in a plurality of stages, the sum of fourth partial risk rates of each of the plurality of stages may be the user's fourth partial risk rate.

A loan ratio of stage order may be a rate of a loan amount, except for a prepayment amount from the user's paid amount among the user's total payment amount. When the stage order is unsubordinated order, a loan rate may be high, and when the stage order is subordinated order, a loan rate may be low.

The average reference risk rate is the same as that of FIG. 5.

The group risk reflection rate may be a rate of the average reference risk rate to a stage order group including stage order.

For example, stage order of a stage having 13 stage participation spaces may be first order (stage order 1) to 13th order (stage order 13). The stage order 1 to the stage order 4 may be included in a first stage order group 610, the stage order 5 to the stage order 8 may be included in a second stage order group 620, and the stage order 9 to the stage order 13 may be included in a third stage order group 630.

The first stage order group 610 may include stage order of unsubordinated order allocated to users having the purpose of a loan, the second stage order group 620 may include stage order of intermediate order allocated to users having the purpose of a loan or investment, and the third stage order group 630 may include stage order of subordinated order allocated to the user having the purpose of investment.

Accordingly, a group risk reflection rate of the first stage order group 610 may be set to 100%, a group risk reflection rate of the second stage order group 620 may be set to 67%, and a group risk reflection rate of the third stage order group 630 may be set to 34%.

FIG. 7 is a conceptual diagram illustrating variable risk elements according to an embodiment of the present invention.

FIG. 7 illustrates a method of calculating a fifth partial risk rate CLA based on CLA information including information about the user's loan amount on the stage and a weight of the CLA information.

Referring to FIG. 7, the fifth partial risk rate CLA may be determined based on a basic risk for each amount and/or a weight according to the stage subscription number. For example, the fifth partial risk rate CLA may be determined based on Equation 3.

Fifth partial risk rate CLA=basic risk for each amount x weight according to the stage subscription number×fifth partial risk rate weight <Equation 3>

Referring to Equation 3, the basic risk for each amount may be a risk rate according to the user's loan amount on the stage.

The user's loan amount on the stage may be a total loan amount of at least one stage to which the user subscribes. When the user subscribes to a plurality of stages, the user's loan amount on the stage may be the sum of a total loan amount of each of a plurality of stages. When the stage is normally ended, a loan amount that has occurred in the corresponding stage may be excluded from the user's total loan amount and when an amount paid is received and a payment amount is normally paid every round, the total loan amount may be reduced.

A standard section ratio may be a ratio value of a risk determined in an increase/decrease unit of 400 thousand won based on 1.2 million won. 1.2 million won may be a loan amount of a user who selects stage order of first order in a stage having a basic payment amount of 100 thousand won and 13 stage participation spaces.

When a standard section ratio is 100%, the basic risk is set to 0.69% and may be a value in which 0.69% is proportionally adjusted according to increase/decrease of the standard section ratio. For example, when the loan amount is 1.2 million won, the standard section ratio may be 100%, and the basic risk may be 0.69%. When the loan amount is 2 million won, the standard section ratio may be 167% and the basic risk may be 1.15%.

A weight according to the stage subscription number may be determined according to the stage subscription number. When the stage subscription number is 1, a weight according to the stage subscription number may be 1, and when the stage subscription number is 2, a weight according to the stage subscription number may be 1.5, and when the stage subscription number is 3, a weight according to the stage subscription number may be 2. That is, a weight according to the stage subscription number may increase according to the stage subscription number.

That is, when the number of stages subscribed by the user increases and when an amount in which the user loans in the stage increases, the fifth partial risk rate CLA may increase.

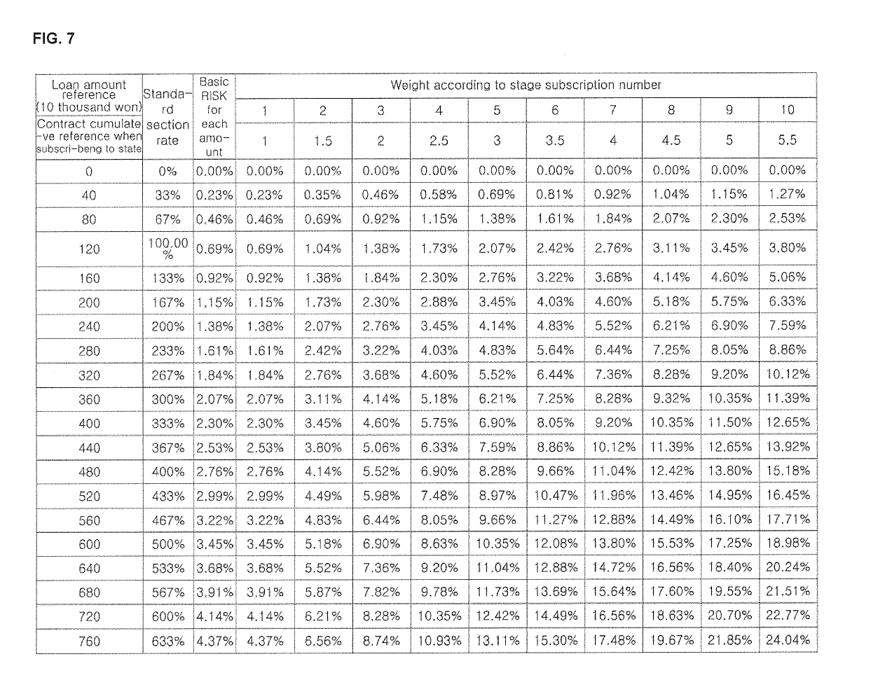

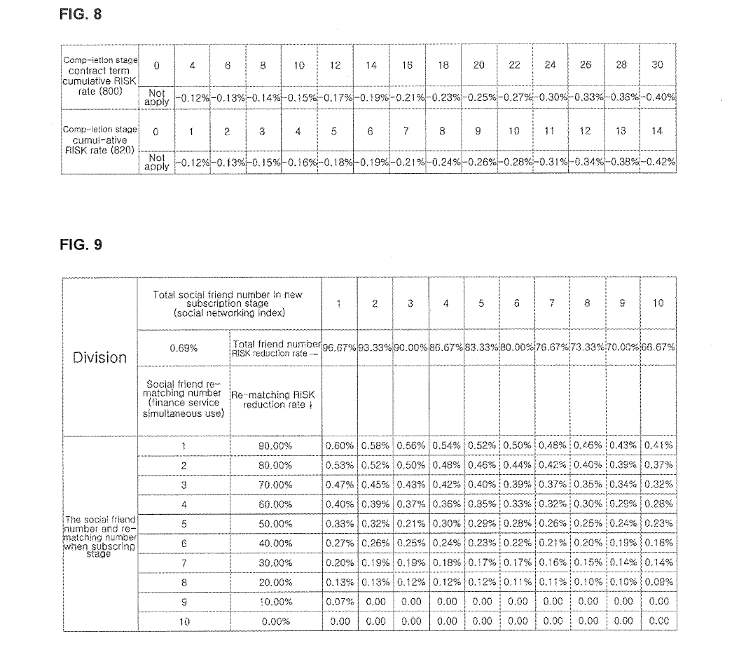

FIG. 8 is a conceptual diagram illustrating variable risk elements according to an embodiment of the present invention.

FIG. 8 illustrates a method of calculating a sixth partial risk rate POU based on POU information including information about the number of stages normally completed by the user and the payment number of the normally completed stage, and a weight of the POU information.

Referring to FIG. 8, the sixth partial risk rate POU may be determined based on a completion stage cumulative risk rate 820 and/or a completion stage contract term cumulative risk rate 800. The sixth partial risk rate POU may be determined based on Equation 4. The sixth partial risk rate may increase the user's credit rating as a negative (−) value.

Sixth partial risk rate POU=(completion stage cumulative risk rate+completion stage contract term cumulative risk rate)×sixth partial risk rate weight <Equation 4>

The completion stage cumulative risk rate 820 may be a risk rate according to the number of completion stages. When the number of completion stages increases, a reduction rate of the completion stage cumulative risk rate 820 may increase. For example, when the number of completion stages increases, a reduction rate of the completion stage cumulative risk rate 820 may increase by 5%.

When payment of a payment amount is performed in a unit of 30 days, the completion stage contract term cumulative risk rate 800 may be determined based on a counted value in a unit of 30 days from an effective start date of the stage to a normal completion date. Alternatively, the completion stage contract term cumulative risk rate 800 may be determined based on an accumulated value by counting the payment number of a completed stage.

When the user has completed a plurality of stages, the completion stage contract term cumulative risk rate may be determined based on an added value by counting in a unit of 30 days from an effective start date to a normal completion date of each of a plurality of completed stages or an accumulated value by counting the payment number of each of a plurality of completed stages.

FIG. 9 is a conceptual diagram illustrating variable risk elements according to an embodiment of the present invention.

FIG. 9 illustrates a method of calculating a seventh partial risk rate SNE based on SNE information including information about the user's social network and a weight of the SNE information.

Referring to FIG. 9, the seventh partial risk rate SNE may be determined based on information about the number of other users (hereinafter, acquaintances in the stage) who form a social network with a user and subscribed to the same stage and information about the re-matching number with acquaintances in the stage. The re-matching number may be the number in which acquaintances in the stage and the user use the same stage. The social network may be generated by a social network service operated by an external server or a social network service operated by a P2P financial service server.

For example, when the user and another user A are in the relationship forming a social network, when the user and another user A have been already together completed the two same stages, and when the user and another user A subscribe to a new stage, the user and another user A may have the re-matching number of three times.

According to an embodiment of the present invention, when many acquaintances are in the stage and many re-matching number with acquaintances are in the stage, the P2P financial service server may reduce the seventh partial risk rate SNE.

Equation 5 is an equation for calculating the seventh partial risk rate SNE.

Seventh partial risk rate SNE=average reference risk rate×acquaintance risk reduction ratio in a stage×acquaintance re-matching reduction ratio in a stage×seventh partial risk rate weight <Equation 5>

The average reference risk rate may be the same as the above-described average reference risk rate. For example, the average reference risk rate may be 0.69.

The acquaintance risk reduction ratio in a stage may be a reduction rate according to the number of acquaintances in the stage. When the number of acquaintances in the stage is relatively many, the acquaintance risk reduction ratio may have a high reduction ratio. When the user subscribes to a plurality of stages, the acquaintance risk reduction ratio in a stage may be determined based on the sum of the number of acquaintances in each of the plurality of stages. The acquaintance risk reduction ratio in a stage may be calculated with an acquaintance risk reduction percent/100 in a stage according to the number of acquaintances in the stage disclosed in the table of FIG. 9.

The acquaintance re-matching reduction ratio in a stage may be a reduction ratio according to the re-matching number with acquaintances in the stage. When the re-matching number with acquaintances in the stage is relatively many, the acquaintance re-matching reduction ratio in a stage may have a high reduction ratio. The acquaintance re-matching reduction ratio in a stage may be calculated with an acquaintance re-matching reduction percent/100 in the stage according to the re-matching number with acquaintances in the stage disclosed in the table of FIG. 9.

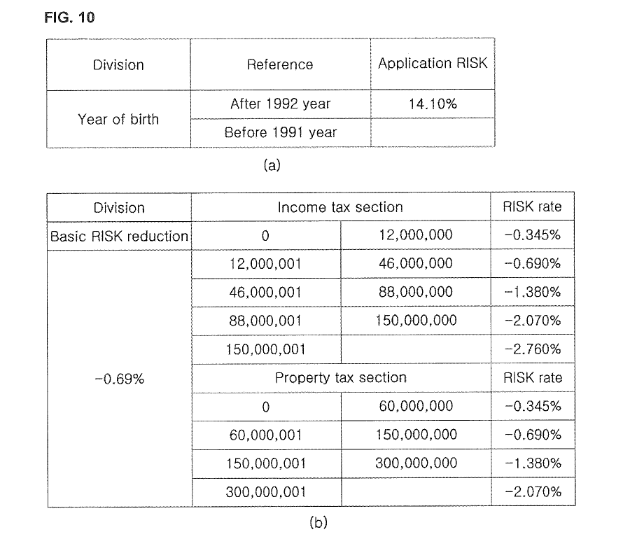

FIG. 10 is a conceptual diagram illustrating variable risk elements according to an embodiment of the present invention.

FIG. 10(a) illustrates a method of calculating an eighth partial risk rate AR based on AR information including information about the user's age and a weight of the AR information.

Referring to FIG. 10(a), in the case of a user born before 1991 year, there is no separate eighth partial risk rate AR, but in the case of a user born after 1992 year, a separate eighth partial risk rate AR may exist. The eighth partial risk rate AR may be calculated based on Equation 6.

Eighth partial risk rate AR=average reference risk rate×AR risk rate×eighth partial risk rate AR weight <Equation 6>

FIG. 10(b) illustrates a method of calculating a ninth partial risk rate DS based on DS information including information about an income/property separately submitted by the user and a weight of the DS information.

Referring to FIG. 10(b), when the user's income tax section is relatively high or when the user's property tax section is relatively high based on information about the user's income tax/property tax, the ninth partial risk rate DS may have a negative (−) value.

The ninth partial risk rate AR may be calculated based on Equation 7.

Ninth partial risk rate AR=[{average reference risk rate×(income tax section weight)}+{average reference risk rate×(property tax section weight)}]x ninth partial risk rate DS weight <Equation 7>

The average reference risk rate may be the same as the above-described average reference risk rate, and the income tax section weight/property tax section weight may be differently applied from 0.5 times to four times according to the income tax section and the property tax section.

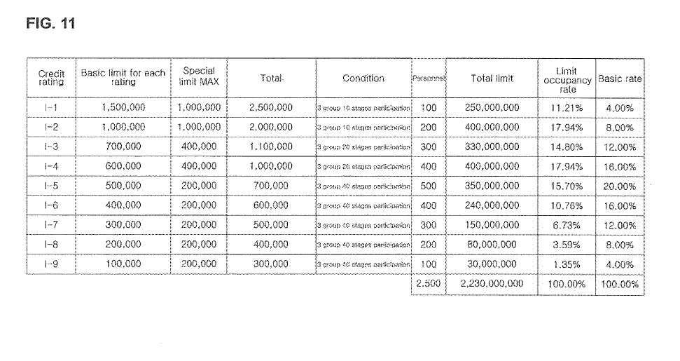

FIG. 11 is a conceptual diagram illustrating a method of determining a user's credit rating according to an embodiment of the present invention.

FIG. 11 illustrates a method of distinguishing a user's credit rating into a first rating to a 15th rating based on a score calculated using a standard risk element and a variable risk element.

Referring to FIG. 11, a user risk rate may be calculated based on the sum of the first partial risk rate to the ninth partial risk rate.

Specifically, the sum of the first partial risk rate NICE and the second partial risk rate CL-BALANCE based on a standard risk rate, the third partial risk rate OPR, the fourth partial risk rate SN, the fifth partial risk rate CLA, the sixth partial risk rate POU, the seventh partial risk rate SNE, the eighth partial risk rate AR, and the ninth partial risk rate DS based on a variable risk rate may be a user risk rate.

The user risk rate may be scored based on a perfect score of 1000. The user risk rate scored with a perfect score of 1000 may be expressed with a term of a user risk score.

FIG. 11 illustrates a range of a user risk rate and a range of a user risk score of each credit rating of a first rating to a 15th rating.

According to an embodiment of the present invention, the P2P financial service server may allow a user (e.g., only the user having a credit rating of a first rating to a ninth rating) having a credit rating of a predetermined rating to subscribe to the stage.

The P2P financial service server may set a maximum value of a basic limit and a special basic limit for different ratings according to the user's credit rating. For example, when the credit rating is high (i.e., closer to the first rating), a basic limit for each rating and a special limit for each rating may increase.

The basic limit for each rating is a limit basically given according to a credit rating, and when the stage is operated in a unit of a month, the basic limit for each rating may be a maximum value of a payment amount that may basically pay in a unit of a month.

The special limit for each rating may be a limit additionally given according to a credit rating. For example, when a user having a credit rating of a first rating participates in stages of 10 or more as a stage order included in a third stage order group described in FIG. 6, the user may obtain the right that may additionally pay 1 million won, which is a maximum value of a special limit for each rating. FIG. 11 illustrates conditions for each credit rating for obtaining a special limit for each rating.

The P2P financial service server may set personnel, a total limit amount, a limit occupancy rate, and a reference rate for each credit rating to adjust elements for determining a credit rating. Structurally, a user risk rate (or user risk score) and a partial risk rate for determining a credit rating may be adjusted so that a person structure of each of credit ratings of a first rating to a ninth rating sequentially has a human structure of a rhombic form.

Persons for each credit rating may be persons set to each credit rating.

The total limit amount for each rating may be a total amount in consideration of a basic limit of persons for each rating and a special limit of persons for each rating.

The limit occupancy rate may be a rate of the total limit amount for each credit rating based on the sum of total limit amounts for each credit rating of each of a plurality of credit ratings.

The reference ratio may be a ratio of persons for each rating based on the total person number.

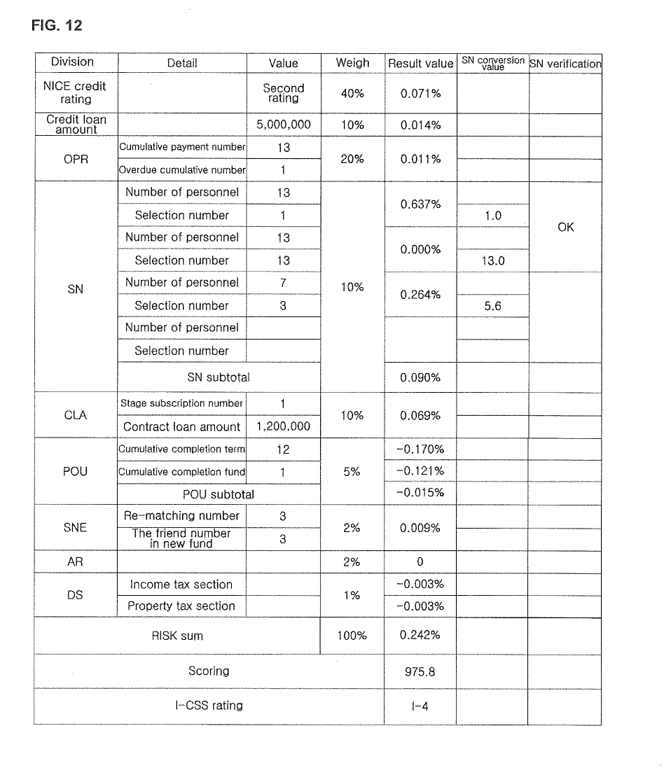

FIG. 12 is a conceptual diagram illustrating a method of determining a real-time credit rating of a P2P financial service server according to an embodiment of the present invention.

FIG. 12 illustrates a method of determining a user's credit rating based on real-time tracking of a first partial risk rate NICE, a second partial risk rate CL-BALANCE, a third partial risk rate OPR, a fourth partial risk rate SN, a fifth partial risk rate CLA, a sixth partial risk rate POU, a seventh partial risk rate SNE, an eighth partial risk rate AR, and a ninth partial risk rate DS of the P2P financial service server.

Referring to FIG. 12, the first partial risk rate NICE may be determined to 0.071% based on the user's NICE credit rating (2 rating) and a first partial risk rate weight (40%).

The second partial risk rate CL-BALANCE may be determined to 0.014% based on the user's credit loan amount (5 million won) and a second partial risk rate weight (10%).

The third partial risk rate OPR may be determined to 0.011% based on the cumulative payment number (13 times), the overdue cumulative number (once), and a third partial risk rate weight (20%).

The fourth partial risk rate SN may be the sum of fourth partial risk rates (0.0637%, 0.000%, 0.264%) of each of a first stage (13 persons, first order), a second stage (13 persons, thirteenth order), and a third stage (7 persons, third order) subscribed by the user.

The fourth partial risk rate of each stage may be determined based on the user's stage order and the fourth partial risk rate weight in each stage.

Stage order for determining a fourth partial risk rate may be adjusted in consideration of the number of entire stage participation spaces (or stage order) of the stage. For example, the order of stages having seven stage participation spaces based on a stage having 13 stage participation spaces may be proportionally adjusted to calculate a fourth partial risk rate. In a stage having seven stage participation spaces, when the stage order is third order, the third order may be proportionally adjusted to 5.6 order (=3×(13/7)) based on a stage having 13 stage participation spaces to calculate the fourth partial risk rate.

The fifth partial risk rate CLA may be 0.069% determined based on the stage subscription number (1), the user's loan amount (1.2 million won), and a fifth partial risk rate weight (10%)

The sixth partial risk rate POU may be −0.015% determined based on the number of the user's cumulative completion stages (1), a contract term (12) of the cumulative completion stage, and a sixth partial risk rate weight (5%).

The seventh partial risk rate SNE may be 0.009% determined based on the number of acquaintances in a stage, the re-matching number of acquaintances in a stage, and a seventh partial risk rate weight (2%).

The eighth partial risk rate AR may be 0% determined based on the user's year of birth and an eighth partial risk rate weight (2%).

The ninth partial risk rate DS may be −0.006% (=−0.003% to 0.003%) determined based on the user's income section information and the user's property tax section information, and a ninth partial risk rate weight (1%).

A user risk rate, which is the sum of the first partial risk rate to the ninth partial risk rate is 0.0242%, the user's risk score is 975.8, and thus the user's credit rating may be determined to a four rating.

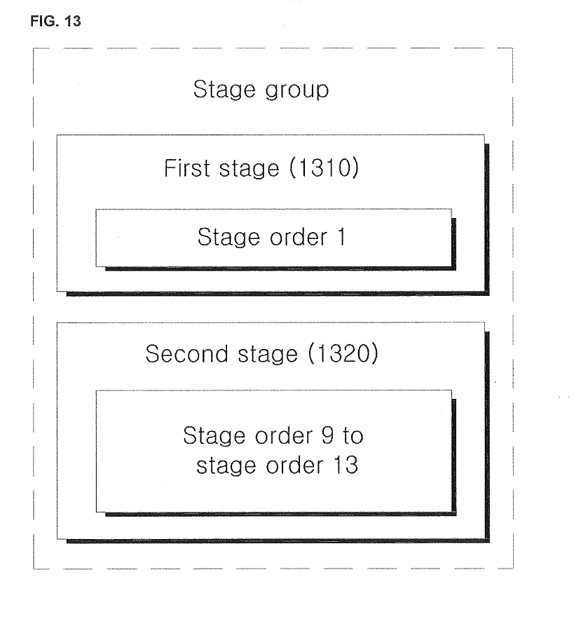

FIG. 13 is a conceptual diagram illustrating a method of determining a stage order according to an embodiment of the present invention.

FIG. 13 illustrates restrictions when determining the user's stage order.

Referring to FIG. 13, the P2P financial service server may be restricted so that the sum of orders of the stage selected by the user does not exceed a threshold value.

For example, grouping of two stages subscribed by the user may be sequentially performed.

When one stage group includes two stages, the sum of orders of stages selected by the user in two grouped stages may be limited so as not to exceed the threshold value (e.g., 10).

Specifically, the user may subscribe to a first stage 1310 and select stage order of the first stage 1310 to first order (stage order 1).

Thereafter, when the user subscribes to a second stage 1320, the stage order of the second stage 1320 may be determined in consideration of a limit in which the sum of the stage order of the second stage 1320 and the stage order of the first stage 1310 should satisfy 10 or more. When the stage order of the first stage 1310 is first order (stage order 1), the stage order of the second stage 1320 of an available user may be one order of ninth order (stage order 9) to 13th order (stage order 13). That is, when the stage order of the second stage 1320 of the user is determined, the P2P financial service server may restrict so that selection of the first order (stage order 1) to the eighth order (stage order 8) is unavailable.

A risk of a stage occurring due to unconditional stage order allocation of unsubordinated order to a specific user based on restrictions on such stage order allocation may be reduced.

When the user subscribes to a third stage, which is another stage other than the first stage group (the first stage 1310 and the second stage 1320), a second stage group may be generated.

Because restrictions on the above-described stage order allocation are applied only in the same stage group, the user may receive allocation of stage order without a separate restriction in the third stage.

When the user selects stage order in a fourth stage, the third stage is included in the same stage group as that of the fourth stage and thus stage order of the fourth stage may be determined in consideration of stage order of the third stage selected by the user.

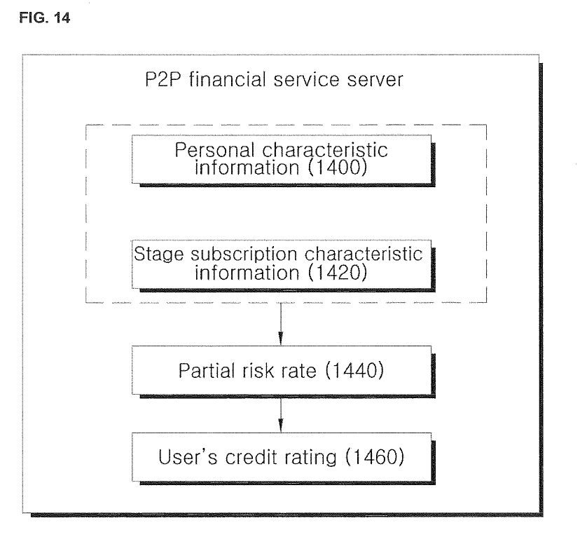

FIG. 14 is a conceptual diagram illustrating a method of determining a user's credit rating based on the user's test results according to an embodiment of the present invention.

FIG. 14 illustrates a method of determining a user's credit rating in consideration of test results (e.g., survey results) provided to the user.

Referring to FIG. 14, the user's personal characteristic information may be obtained based on questions provided to the user.

Table 4 illustrates questions provided to the user.

TABLE 4

I am going to the appointment place with enough margin.
I tend to break it when it is damaging to keep a promise.
If any provision is unreasonable, it should be kept as
long as it exists.
Sometimes I can lie a bit to get what I want.
I cannot imagine damaging someone with my fault.
I am a reliable person to practice what I say.
I plan to do things in advance in the future.
I often act recklessly.
I have more qualities to lead them than to follow others.
I try to do things the way I do.
If I own more material, my life will be better.
I am very interested in improving economic conditions
through stable investment.

The user's personal characteristics information may be determined based on the user's answer to the above survey.

For example, the user's personal characteristic information 1400 may include self-esteem, self-satisfaction, self-efficacy, public self-consciousness, self-discipline, norm compliance, responsibility, planning, initiative, materialistic desire, sociability, favorability, openness, others care, relationship desire, friends, promise execution, fund interest, booking service, and social network service (SNS) activities.

The P2P financial service server may analyze the relationship between personal characteristic information 1400 of users who have subscribed to the stage and stage subscription characteristic information 1420 of the user.

The stage subscription characteristic information 1420 of the user may include the user's stage completion information, overdue information of the user's payment amount, and stage order information selected by the user.

For example, the P2P financial service server may calculate a separate partial risk rate based on the personal characteristic information 1400 through analysis between the personal characteristic information 1400 and the stage subscription characteristic information 1420 to reflect the separate partial risk rate to the user's credit rating. A risk rate according to personal characteristic information may be calculated in consideration of stage completion information of a user having specific personal characteristic information 1400 and overdue information of the user's payment amount.

As another example, the P2P financial service server may group the user to one group of a plurality of user characteristic groups based on the personal characteristic information 1400. The P2P financial service server may calculate a separate partial risk rate for each user characteristic group to reflect the separate partial risk rate to the user's credit rating.

An analysis result between the personal characteristic information 1400 and the stage subscription characteristic information 1420 of such a P2P financial service server may be continuously fed back, and a separate partial risk rate (or a separate partial risk rate according to a user characteristic group) according to the personal characteristic information 1400 may be adjusted according to the feedback result.

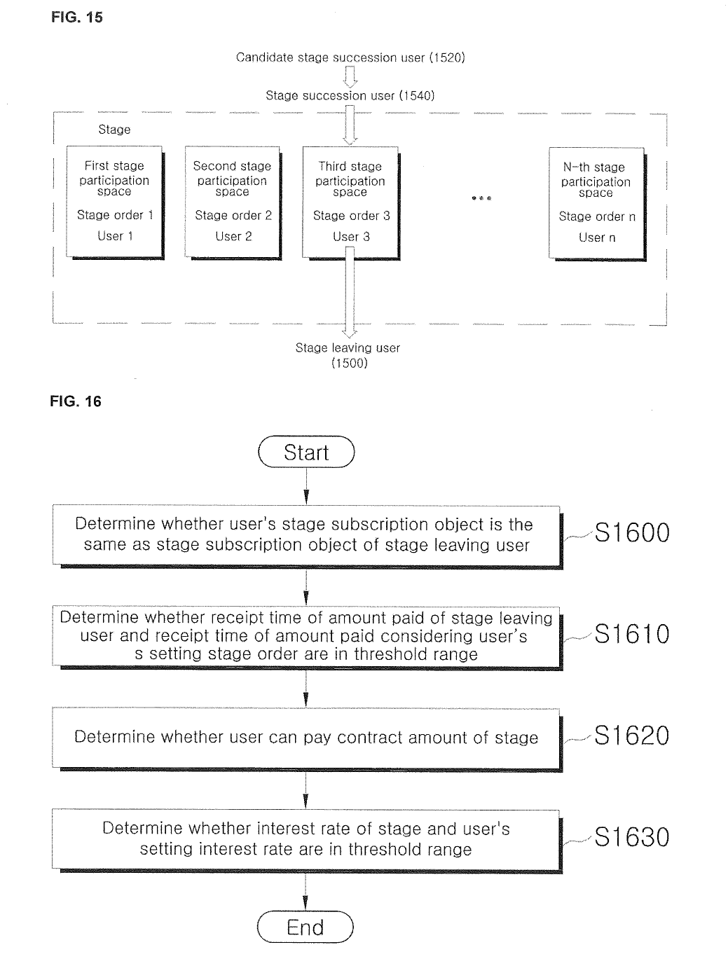

FIG. 15 is a conceptual diagram illustrating succession among users in a stage according to an embodiment of the present invention.

FIG. 15 illustrates a method of performing succession among users while proceeding the stage.

Referring to FIG. 15, for example, when delinquency of a continued payment amount of a particular user occurs while proceeding the stage or when a credit rating of a particular user declines to a credit rating that may not participate in the stage while proceeding the stage, participation of the particular user to the stage may be limited and another user may succeed the particular user to subscribe to the stage. Hereinafter, a user who succeeds the stage participation space (or stage order) may be expressed with a term of a stage succession user 1540, and a user who succeeds to a succession user may be expressed with a term of a stage leaving user 1500.

According to an embodiment of the present invention, the P2P financial service server may select a candidate stage succession user 1520 and perform a determination procedure on whether a stage participation space (or stage order) of the stage leaving user 1500 is succeeded to the candidate stage succession user 1520.

The candidate stage succession user 1520 may be determined based on information about a preset stage that can be participated (or be interested) by the user. The candidate stage succession user 1520 may be an additionally preset user that can participate in the stage through succession among users.

For example, the user may set information about participation personnel of the stage, a contract amount, an interest rate, stage order, and a category as information (hereinafter, interest stage information) about a stage that can participate.

Information about participants of a stage preset by the user may be expressed with a term of information about user setting stage participants, information about a contract amount of a stage preset by the user may be expressed with a term of information about a user setting contract amount, information about a contract interest rate of a stage preset by the user may be expressed with a term of user setting contract interest rate information, information about stage order preset by the user may be expressed with a term of user setting stage order information, and information about a stage category preset by the user may be expressed with a term of user setting stage category information.

When a leaving user occurs in a stage of the same characteristic/similar characteristic to that of a desired stage of the user based on the interest stage information set by the user, the P2P financial service server may determine the user to the candidate stage succession user 1520 and determine whether the user is to subscribe to the stage as the stage succession user 1540.

In order to determine whether a stage in which a stage leaving user occurs is the same as/similar to an interest stage in which the user wants, the P2P financial service server may perform the following determination procedure.

FIG. 16 is a conceptual diagram illustrating a determination procedure of a P2P service financial server for succession among users in a stage according to an embodiment of the present invention.

FIG. 16 illustrates a determination procedure of a P2P service financial server for succession among users while proceeding a stage.

Referring to FIG. 16, the P2P service financial server determines whether the user's stage subscription object is the same as the stage subscription object of the stage leaving user (step S1600).

The user's stage subscription object may be determined by a stage order group including user setting stage order. The stage subscription object of the stage leaving user may be determined by a stage order group including stage order of the stage leaving user. The user's stage subscription object may be determined to a loan or investment based on a stage order group.

The P2P financial service server determines whether a receipt time of an amount paid of the stage leaving user and a receipt time of an amount paid in consideration of the user's setting stage order are in a threshold range (step S1610).

For example, when a receipt time of an amount paid of the stage leaving user is after three payment rounds based on a current time point, when the user's setting stage order is second order, and when a threshold range is −1 order to +1 order, the receipt time of an amount paid of the stage leaving user and the receipt time of an amount paid in consideration of the user setting stage order may be in a threshold range.

The P2P financial service server determines whether the user can pay a contract amount of the stage (step S1620).

The P2P financial service server may determine whether the user can pay a contract amount set to the stage in consideration of a limit of the user's credit rating (basic limit for each rating, special limit for each rating).

The P2P financial service server determines whether an interest rate of the stage and the user's setting interest rate are in a threshold range (step S1630).

For example, when an interest rate of a stage in which the stage leaving user occurs is 7%, the user's setting interest rate is 5%, and the threshold range is −2% to +2%, an interest rate of the stage in which the stage leaving user occurs and the user's setting interest rate may be in a threshold range.

When the steps S1600 to S1630 are satisfied, the P2P financial service server may determine a stage in which the stage leaving user has occurred to a stage having high similarity with an interest stage in which the user wants. The P2P financial service server may provide information about the stage and determine whether the user is to subscribe to the stage as a stage succession user of the stage.

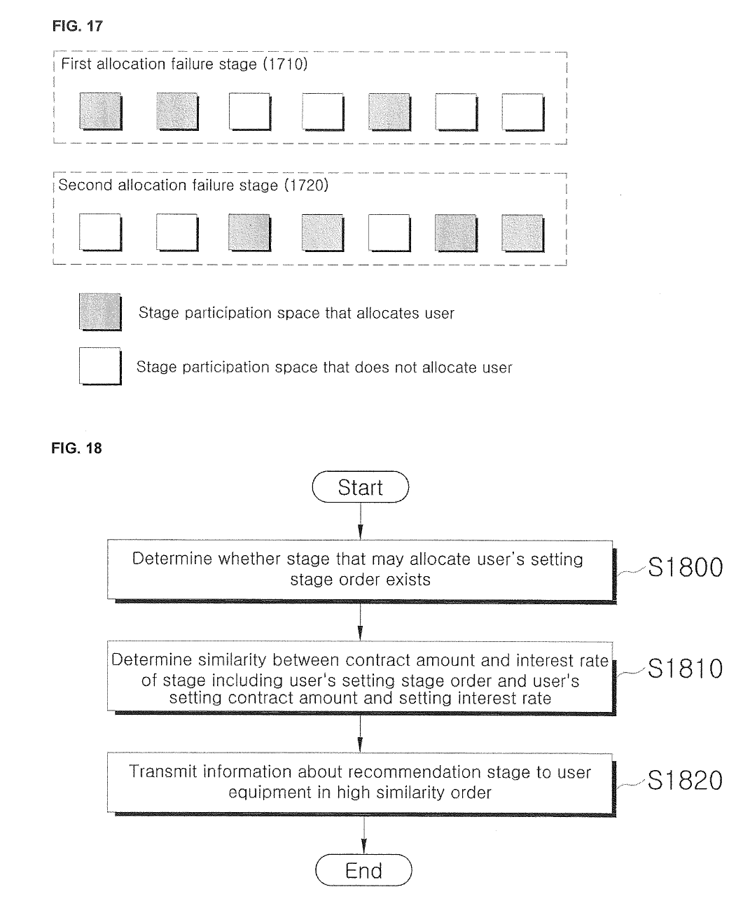

FIG. 17 is a conceptual diagram illustrating a combination procedure between stages according to an embodiment of the present invention.

FIG. 17 illustrates a method of generating a stage through a combination between stages that do not allocate all stage participation spaces (or stage order).

Referring to FIG. 17, the P2P financial service server may set a time limit in a generated stage to recruit users to participate in the stage.

When the P2P financial service server does not allocate users to all stage participation spaces of a stage (first allocation failure stage 1710) within a preset time limit, the P2P financial service server may generate an allocation success stage through a combination with another stage (second allocation failure stage 1720) that does not allocate users to all stage participation spaces of the stage within the preset time limit.

Hereinafter, for convenience of description, a case of generating an allocation success stage based on a combination of two allocation failure stages is disclosed, but an allocation success stage may be generated based on a combination of two or more allocation failure stages.

Specifically, for a combination of the first allocation failure stage 1710 and the second allocation failure stage 1720, the P2P financial service server may determine similarity of a stage characteristic of the first allocation failure stage 1710 and a stage characteristic of the second allocation failure stage 1720.

Similarity between the first allocation failure stage 1710 and the second allocation failure stage 1720 may be determined through comparison between first participation personnel (or first stage participation space) set to the first allocation failure stage 1710, a first contract amount, a first interest rate, and second participation personnel (or second stage participation space) set to the second allocation failure stage 1720, a second contract amount, and a second interest rate. Similarity between allocation failure stages may be calculated by setting a highest weight to participants.

When similarity of a stage characteristic of the first allocation failure stage 1710 and a stage characteristic of the second allocation failure stage 1720 is a threshold value or more, the P2P financial service server may determine whether a stage participation space allocated to the first allocation failure stage 1710 and a stage participation space allocated to the second allocation failure stage 1720 are overlapped.

When a stage participation space allocated to the first allocation failure stage 1710 and a stage participation space allocated to the second allocation failure stage 1720 are not overlapped, the first allocation failure stage 1710 and the second allocation failure stage 1720 may be set to a combination candidate.

Even when a stage participation space allocated to the first allocation failure stage 1710 and a stage participation space allocated to the second allocation failure stage 1720 are overlapped, if stage participation spaces of previous stage order and subsequent stage order of stage order of the overlapped stage participation space are empty, the first allocation failure stage 1710 and the second allocation failure stage 1720 may be set to a combination candidate under agreement of movement to the stage participation space of at least one user of users, having received allocation of the overlapped stage participation space.

The P2P financial service server may provide a new contract amount and a new interest rate to a user who participates in the first allocation failure stage 1710 and a user who participates in the second allocation failure stage 1720 based on a first contract amount, a first interest rate, a second contract amount, and a second interest rate.

The new contract amount may be a minimum value (or an average of the first contract amount and the second contract amount) of the first contract amount and the second contract amount, and the new interest rate may be a maximum value (or an average of the first contract amount and the second contract amount) of the first interest rate and the second interest rate.

When a user who participates in the first allocation failure stage 1710 and a user who participates in the second allocation failure stage 1720 agree in a new contract amount and a new rate, the first allocation failure stage 1710 and the second allocation failure stage 1720 may be combined and be started as an allocation success stage.

FIG. 18 is a conceptual diagram illustrating a method of recommending a stage to a user according to an embodiment of the present invention.

FIG. 18 illustrates a method of inducing subscription to a stage opened to the user through recommendation.

Referring to FIG. 18, the P2P service financial server determines whether a stage that may allocate the user's setting stage order exists among opened stages (step S1800).

The user's setting stage order may be directly set by the user, but may be determined based on the record of a stage in which the user has been previously participated. For example, when the user selects stage order to only first order to third order in the stage in which the user has been previously subscribed, the user's setting stage order may be determined to first order to third order.

The P2P financial service server determines similarity between a contract amount and an interest rate of the stage including the user's setting stage order and the user's setting contract amount and setting interest rate (step S1810).

The user's setting contract amount and setting interest rate may be directly set by the user, but may be determined based on the record of the stage in which the user has been previously participated. For example, the user's setting contract amount and setting interest rate may be set based on the record of a contract amount and interest rate of the stage in which the user has been previously subscribed.

Similarity between a contract amount and interest rate of the stage and the user's setting contract amount and setting rate may be determined based on first partial similarity between a contract amount of the stage and a setting contract amount and second partial similarity between an interest rate of the stage and a setting interest rate. For example, when a setting contract amount and a contract amount are the same, the first partial similarity has a maximum value, and when a difference between a setting contract amount and a contract amount increases, the first partial similarity may be set to have low similarity. In this case, when a contract amount is larger than a setting contract amount, similarity may be reduced relatively more quickly than when a contract amount is smaller than a setting contract amount.

For example, the second partial similarity may be determined differently according to the user's setting stage order.

When the user's setting stage order is unsubordinated order for the purpose of a loan, if an interest rate of the stage is smaller than a setting rate, similarity may become relatively high, however when the user's setting stage order is subordinated order for the purpose of investment, if an interest rate of the stage is larger than a setting rate, similarity may become relatively high.

The P2P financial service server transmits information about a recommendation stage to the UE in high similarity order (step S1820).

The P2P financial service server may transmit recommendation stage information including opened stage information to the UE in high order of calculated similarity. The user may select and subscribe to a stage based on the recommendation stage information.

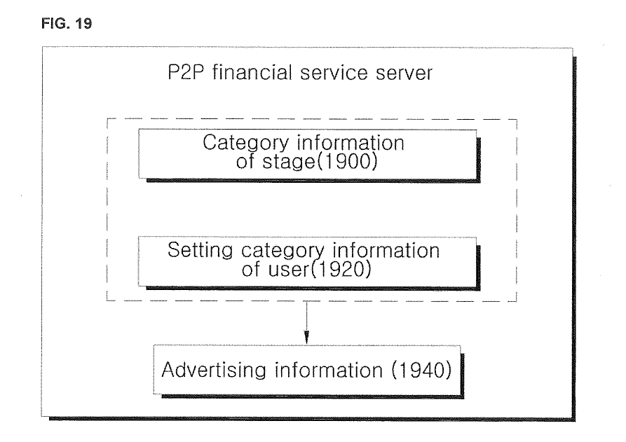

FIG. 19 is a conceptual diagram illustrating a method of transmitting product advertisement information to a user in consideration of category information of a stage according to an embodiment of the present invention.

FIG. 19 illustrates a method of transmitting advertisement information when a user performs a stage-based P2P financial application in consideration of information about a stage category set to the stage.

Referring to FIG. 19, a category of the stage may be set, as described above.

Information about the category of the stage may include information about a product wanting to purchase with an amount paid received through the stage. For example, the category of the stage may be set to a lump sum, computer/electronic appliance, travel, fashion accessories, beauty, musical instruments, wedding, baby, furniture/interiors, automotive/motorcycle, sporting goods, medical/smart devices, and the like. The category of the stage may be more specifically defined and set to a specific product.

The P2P financial service server may transmit advertisement information 1940 to a UE of a user who subscribes the stage based on category information 1900 of the stage. When the category information of the stage is set to a computer/electronic appliance, if the user executes the stage-based P2P financial application, the P2P financial service server may output an advertisement of a laptop computer, computer, and electronic appliance as a banner advertisement.

As another example, advertising information 1940 for each user may be transmitted in consideration of setting category information 1920 of users who have subscribed to the stage. When users subscribe to the stage, the users may input category information, and the P2P financial service server may transmit personalized advertising information 1940 adaptive to the user based on the category information input by the user.

According to an embodiment of the present invention, a group purchase may be performed in consideration of setting category information of users subscribed to the stage. When products to purchase are the same based on an amount paid received within a predetermined time period, in order for the user to purchase the product with a lower price, the P2P financial service server may perform a group purchase procedure of the products.

The foregoing embodiments according to the present invention are implemented in the form of program instructions that may be executed through various computer components to be recorded in a computer readable recording medium. The computer readable medium may include a program instruction, a data file, and a data structure in single or in combination. The program instruction recorded at the computer readable recording medium may be specially designed and configured for the present invention or may be known to and used by a person of ordinary skill in a computer software field. The computer readable recording medium may include, for example, a magnetic medium such as a hard disk, a floppy disk, and a magnetic tape, an optical recording medium such as a compact disk read-only memory (CD-ROM) or a digital versatile disk (DVD), a magnetic-optical medium such as a floptical disk, and a hardware device, specially configured to store and perform a program instruction, such as a ROM, a random-access memory (RAM), and a flash memory. The program instruction may include, for example, a high-level language code that may be executed by a computer using an interpreter as well as a machine language code formed by a compiler. The hardware device may be changed to one or more software modules in order to perform a process according to the present invention, and vice versa.

While the present invention has been particularly shown and described with reference to exemplary embodiments thereof, it is to be understood that the invention is not limited to the disclosed embodiments, but, on the contrary, those skilled in the art will appreciate that various modifications and changes may be made thereto without departing from the scope of the present invention.

Accordingly, the scope of the invention is not limited to the foregoing embodiment and the full range equal to claims or changed equivalently from claims as well as claims to be described later belongs to the scope of the spirit of the invention.

### INDUSTRIAL APPLICABILITY

The present invention may be used in online and mobile-based P2P finance industry.

1. A method of operating a peer-to-peer (P2P) financial service based on a stage, the method comprising:
receiving, by a P2P financial service server, a transmission request of a stage-based P2P financial application from a user equipment directly or indirectly through a relay server; and
transmitting, by the P2P financial service server, the stage-based P2P financial application to the user equipment directly or indirectly through the relay server,
wherein the stage-based P2P financial application is implemented to generate a stage or participate in a stage based on the user equipment, the stage comprises a plurality of stage participation spaces, the plurality of stage participation spaces sequentially correspond to a plurality of stage orders, respectively, the user's payment amount and/or amount paid are/is determined on the stage according to a stage order allocated to a user of the user equipment among the plurality of stage orders, and a paid time of the amount paid on the stage is determined according to the stage order.

2. The method of claim 1, wherein the P2P financial service server groups the plurality of stages to set at least one stage group, when the user subscribes to a plurality of stages, and the P2P financial service server determines the user's stage order in the second stage based on the user's stage order in the first stage, when the at least one stage group comprises a first stage and a second stage.

3. The method of claim 2, wherein, when the first stage and the second stage each do not allocate all stage participation spaces, the P2P financial service server sets the first stage and the second stage to an allocation failure stage, and when similarity between characteristic information of the first stage and characteristic information of the second stage is a threshold value or more, the P2P financial service server sets the first stage and the second stage as combination candidates for combining to one allocation success stage in consideration of a first stage participation space of the first stage and a second stage participation space of the second stage.

4. The method of claim 1, further comprising:
determining, by the P2P financial service server, whether generation or participation of the stage is available based on the user's first credit rating; and
determining, by the P2P financial service server, a second credit rating in which the first credit rating is adjusted based on the user's use records in the stage while operating the stage,
wherein the first credit rating is determined based on the user's use records in a previous stage through the stage-based P2P financial application, and
the second credit rating is adjusted based on the user's use records in the stage.

5. The method of claim 4, wherein the first credit rating is determined based on information related to whether the previous stage is completed, information related to a previous stage order selected at the previous stage, and information related to delinquency of a previous payment amount at the previous stage,
the second credit rating is adjusted based on information about the stage order and information related to delinquency of the payment amount, and
a selectable range of the stage order is determined based on another stage order selected by the user in another stage.

6. The method of claim 5, wherein the second credit rating is determined by further considering information about other user who form a social network with the user in the stage.

7. A P2P financial service server for operating a peer-to-peer (P2P) financial service based on a stage, the P2P financial service server comprising:
a communication unit for communicating with a relay server or a user equipment; and
a processor operatively connected to the communication unit,
wherein the processor is implemented to receive a transmission request of a stage-based P2P financial application from the user equipment directly or indirectly through a relay server, and to transmit a stage-based P2P financial application to the user equipment directly or indirectly through the relay server,
the stage-based P2P financial application is implemented to generate a stage or participate in a stage based on the user equipment,
the stage comprises a plurality of stage participation spaces,
the plurality of stage participation spaces sequentially correspond to a plurality of stage orders, respectively,
the user's payment amount and/or amount paid are/is determined on the stage according to a stage order allocated to a user of the user equipment among the plurality of stage orders, and
a paid time of the amount paid is determined on the stage according to the stage order.

8. The P2P financial service server of claim 7, wherein the P2P financial service server groups the plurality of stages to set at least one stage group, when the user subscribes to a plurality of stages, and the P2P financial service server determines the user's stage order in the second stage based on the user's stage order in the first stage, when the at least one stage group comprises a first stage and a second stage.

9. The P2P financial service server of claim 8, wherein, when the first stage and the second stage each do not allocate all stage participation spaces, the P2P financial service server sets the first stage and the second stage to an allocation failure stage, and when similarity between characteristic information of the first stage and characteristic information of the second stage is a threshold value or more, the P2P financial service server sets the first stage and the second stage as combination candidates for combining to one allocation success stage in consideration of a first stage participation space of the first stage and a second stage participation space of the second stage.

10. The P2P financial service server of claim 7, wherein the processor is implemented to determine whether generation or participation of the stage is available based on the user's first credit rating and to determine a second credit rating in which the first credit rating is adjusted based on the user's use records in the stage while operating the stage,
wherein the first credit rating is determined based on use records in the user's previous stage through the stage-based P2P financial application, and
the second credit rating is adjusted based on the user's use records in the stage.

11. The P2P financial service server of claim 10, wherein the first credit rating is determined based on information related to whether the previous stage is completed, information related to a previous stage order selected in the previous stage, and information related to delinquency of a previous payment amount at the previous stage,
the second credit rating is adjusted based on information about the stage order and information related to delinquency of the payment amount, and
a selectable range of the stage order is determined based on another stage order selected by the user in another stage.

12. The P2P financial service server of claim 11, wherein the second credit rating is determined by further considering information about other users who form a social network with the user in the stage.

13. A computer readable recording medium on which a computer program for executing a method according to claim 1 is recorded.

14. A computer readable recording medium on which a computer program for executing a method according to claim 2 is recorded.

15. A computer readable recording medium on which a computer program for executing a method according to claim 3 is recorded.

16. A computer readable recording medium on which a computer program for executing a method according to claim 4 is recorded.

17. A computer readable recording medium on which a computer program for executing a method according to claim 5 is recorded.

18. A computer readable recording medium on which a computer program for executing a method according to claim 6 is recorded.
